(19) United States
(12) Patent Application Publication
(10) Pub. No.: US 2013/0264861 A1
(43) Pub. Date: Oct. 10, 2013

(54) WHEEL ASSEMBLY OF IN-WHEEL SYSTEM

(71) Applicant: SAMSUNG ELECTRONICS CO., LTD., Suwon-si (KR)

(72) Inventor: Tae-Sang PARK, Suwon-si (KR)

(73) Assignee: SAMSUNG ELECTRONICS CO., LTD., Suwon-si (KR)

(21) Appl. No.: 13/752,846

(22) Filed: Jan. 29, 2013

(30) Foreign Application Priority Data
Apr. 5, 2012 (KR) 10-2012-0035672

(51) Int. Cl. B60K 11/06; B60K 7/00

(52) U.S. Cl. CPC B60K 11/06; B60K 7/0007
USPC 301/6.5

(57) ABSTRACT

A wheel assembly for an in-wheel system is provided. The wheel assembly includes a driving motor configured to generate rotational power; a motor housing configured to accommodate the driving motor and including a plurality of fins on an outer surface thereof; and a wheel configured to accommodate the motor housing inside, to be rotated by the rotational power from the driving motor, and to provide an air flow to cool the motor housing when rotated.

### CROSS-REFERENCE TO RELATED APPLICATION

This application claims priority from Korean Patent Application No. 10-2012-0035672, filed on Apr. 5, 2012 in the Korean Intellectual Property Office, the entire disclosure of which is incorporated herein by reference.

### BACKGROUND

1. Field

The following description relates to a wheel assembly of an in-wheel system applicable to a vehicle, such as an electric automobile, which is driven with electrical power.

2. Description of the Related Art

Hybrid vehicles and electric vehicles have gained more popularity due to the harmful environmental effects from air pollution and an increasing shortage of fossil fuels. A hybrid vehicle mainly uses an internal-combustion engine to generate power and uses an electric motor as an auxiliary power source. An electric vehicle uses an electric motor as a main power source.

With the development of technologies for batteries and motors, it is expected that electric vehicles, known as pollution-free cars, will replace “transition” vehicles, such as hybrid cars, since electric vehicles do not emit pollutants or carbon dioxide while driving.

An in-wheel system has a driving motor mounted on a wheel and delivers power from the driving motor directly to the wheel. The application of the in-wheel system allows a vehicle to have a compact and organized driving system, thereby reducing vehicle weight and improving the degree of freedom in vehicle layout or design. In addition, the in-wheel system contributes to optimizing a vehicle frame to thereby increase collision safety, and increases the drive motor performance of the vehicle and facilitates a larger interior space by optimally balancing the weight across the vehicle.

In addition, in the in-wheel system, the driving motor is required to be small and high-powered since it is mounted inside the wheel. However, a higher-power driving motor produces more heat due to power loss. Further, a smaller driving motor is more likely to exceed the maximum allowable temperature of a stator coil since it has a smaller heat radiation area necessary for the cooling process. Accordingly, the small, high-power driving motor may be affected by the heat and thereby its durability and performance are degraded. Hence, there is a need for a method to efficiently cool a driving motor.

### SUMMARY

According to an aspect of embodiment, there is provided a wheel assembly of an in-wheel system, including: a driving motor configured to generate rotational power; a motor housing configured to accommodate the driving motor, the motor housing comprising a plurality of fins on an outer surface thereof; and a wheel configured to accommodate the motor housing inside, to be rotated by the rotational power generated by the driving motor, and to provide an air flow to cool the motor housing when rotated.

Other features and aspects may be apparent from the following detailed description, the drawings, and the claims.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a diagram of a wheel assembly of an in-wheel system according to an exemplary embodiment;

FIG. 2 is a perspective view of the wheel assembly of FIG. 1;

FIG. 3 is an exploded perspective view of the wheel assembly shown in FIG. 2 according to an exemplary embodiment;

FIG. 4 is a perspective view of a part of the wheel assembly shown in FIG. 2 according to an exemplary embodiment;

FIG. 5 is a cross-sectional view of wheel assembly taken along the line A-A in FIGS. 2; and

FIG. 6 is a perspective view of a part of the wheel assembly shown in FIG. 2 according to another exemplary embodiment.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Throughout the drawings and the detailed description, unless otherwise described, the same drawing reference numerals will be understood to refer to the same elements, features, and structures. The relative size and depiction of these elements may be exaggerated for clarity, illustration, and convenience.

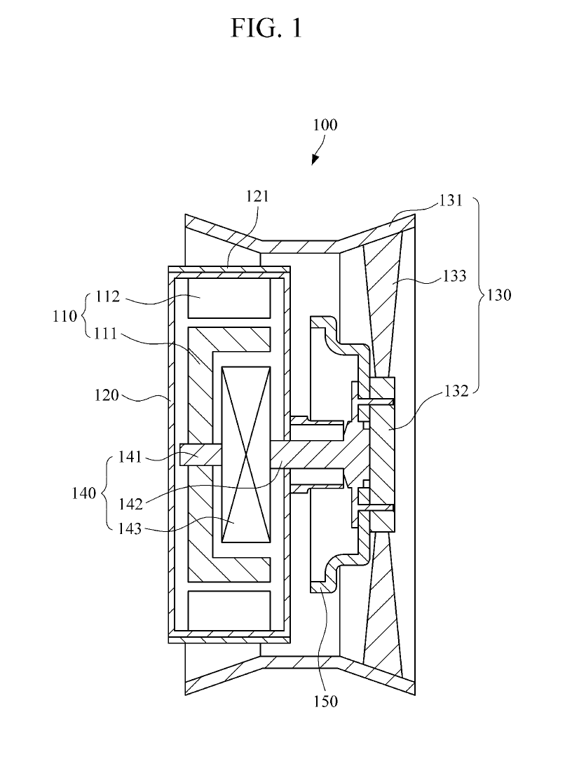

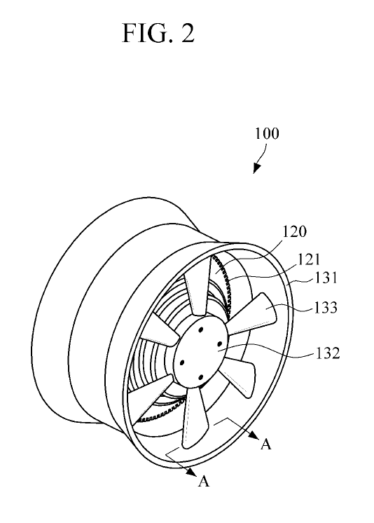

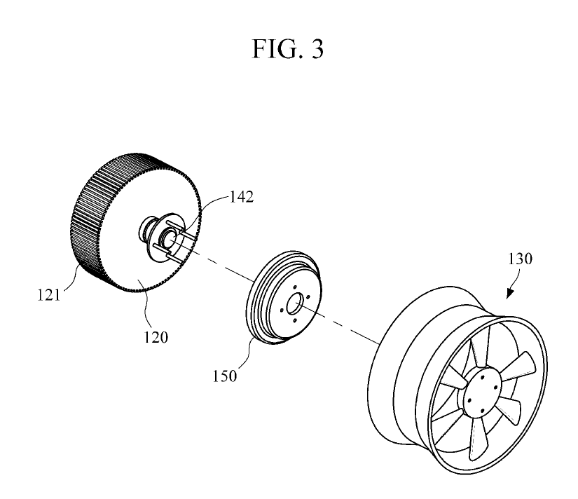

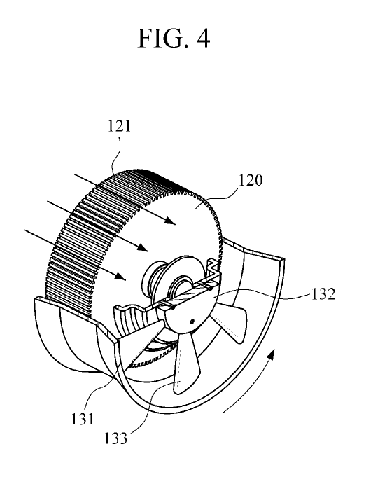

FIG. 1 is a diagram illustrating an example of a wheel assembly of an in-wheel system according to an exemplary embodiment. FIG. 2 is a perspective view of the wheel assembly of FIG. 1. FIG. 3 is an exploded perspective view of the wheel assembly shown in FIG. 2 according to an exemplary embodiment. FIG. 4 is a perspective view of a part of the wheel assembly shown in FIG. 2 according to an exemplary embodiment.

Referring to FIGS. 1 to 4, the wheel assembly 100 of the in-wheel system includes a driving motor 110, a motor housing 120, and a wheel 130.

The driving motor 110 may generate motive power to rotate the wheel 130. The motor housing 120 accommodates the driving motor 110. A plurality of fins 121 are provided on an outer surface of the motor housing 120. For example, the motor housing 120 may have a cylindrical shape and the fins 121 may protrude from an outer circumferential surface of the motor housing 120 in a radial direction. The fins 121 may be air cooled fins to improve the heat radiation performance of the motor housing 120. The fins 121 protrude from the outer surface of the motor housing 120 to thereby expand the cooling surface of the motor housing 120 contacting air. Accordingly, heat generated by the driving motor 110 during operation of the driving motor 110 may be dissipated by a heat exchange between the cooling surface of the driving motor 110 and ambient air.

The wheel 130 may be configured such that a tire can be mounted on an outer circumference of a rim of the wheel 130 and rotated with the rotational movement of the wheel 130. The wheel 130 accommodates the motor housing 120 inside, and is rotated by rotational power transferred from the driving motor 120. The wheel 130 may have an air-blowing function when it is rotating.

The air blown by the wheel 130 may create an air flow and convergence around the fins 121. For example, in the course of discharging air sucked by the wheel 130 from the motor housing 120 to the outside of the wheel 130, an air flow may be formed and convergence around the fins 121. For another example, in the course of delivering air sucked by the wheel 130 from the outside of the wheel 130 to the motor housing 120, an air flow that converges around the fins 121 may be formed.

As air flow around the fins 121 increases, the heat exchange between ambient air and the fins 121 and between the ambient air and the motor housing 120 can be increased. Accordingly, cooling effect on the motor housing 120, and ultimately, the driving motor 110 inside the motor housing 120, may be increased. Thus, a compact, high-power driving motor 110 may be utilized for the wheel assembly 100. Further, the degradation of durability and performance of the driving motor 110 may be prevented.

The wheel 130 includes the rim 131, a hub 132, and a plurality of blades 133. The rim 131 is ring-shaped to enclose the circumference of the motor housing 120. In addition, the outer circumference of the rim 131 is formed in a shape for mounting a tire thereon.

The hub 132 is rotated by rotational power transferred from the driving motor 110. The hub 132 is disposed in an inner space enclosed by the rim 131. The center of the hub 132 is concentric to the center of the rim 131.

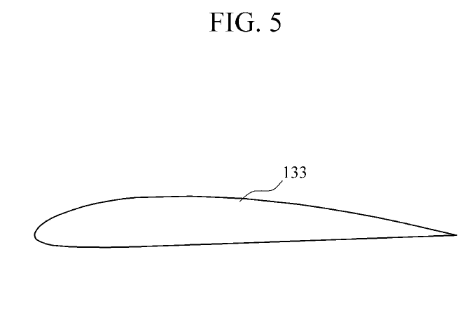

Between the rim 131 and the hub 132, the blades 133 are arranged around a rotational axis of the hub 132. The blades 133 have the same shape as each other, and may be arranged at predetermined intervals around the rotational axis of the hub 132. One end of each blade 133 is connected to the rim 131 and the other end is connected to the hub 132. The blades 133 and the rim 131 are rotated with the rotation of the hub 132. During the rotation of the hub 132, the blades 133 have an air-blowing function. Each blade 133 has a cross-sectional area shaped as shown in FIG. 5 for the air-blowing function.

Under the condition that the wheel 130 rotates in a predetermined direction, the blades 133 may have a shape such that when the blades 133 are rotated the air from the housing 120 is sent to the outside of the wheel 130, or a shape such that when the blades 133 are rotated the air from the outside of the wheel 130 is sent to the motor housing 120. For example, the wheel assembly 100 is mounted on a vehicle, and the blades 133 may have a shape that sends the air from the motor housing 120 to the outside of the wheel 130, or vice versa, when the vehicle is driving forward.

Referring back to FIGS. 1 to 4, the driving motor 110 may include a rotor 111 and a stator 112. The rotor 111 is arranged at a middle of the motor housing 120. The stator 112 is arranged around the rotor 111 inside the motor housing 120, and fixed to the inner wall of the motor housing 120. For example, the stator 112 may have a hollow cylindrical shape. The rotor 111 may be rotatably inserted in an interior of the stator 112.

The rotor 111 may have a permanent magnet, and the stator 112 may have a stator coil wound around it. In response to current provided to the stator coil while a magnetic field is generated by the permanent magnet, the rotor 111 is rotated by electromagnetic power. During operation of the driving motor 110, heat produced by the stator coil can be efficiently cooled by the fins 121 and the wheel having the air-blowing function. In addition, the driving motor 110 may be an outer driving motor that has a rotor rotatably coupled around a stator to thereby be provided with power.

The wheel assembly 100 may include a decelerator 140. The decelerator 140 decelerates a rotational speed of the rotor 111 and transfers the decelerated rotational speed to the wheel 130. The decelerator 140 may include an input shaft 141, an output shaft 142, and a gear module 143. The input shaft 141 is fixed to the rotor 111 so as to be rotated with the rotor 111. The output shaft 142 is fixed to the hub 132 of the wheel 130. Accordingly, the wheel 130 is configured to rotate according to the rotation of the output shaft 142.

The gear module 143 reduces the number of rotations of the input shaft 141, thereby enabling the output shaft 142 to rotate at the reduced number of rotations. The gear module 143 may be configured in various ways to acquire a predetermined deceleration rate. The decelerator 140 may convert high-speed and low-torque driving of the driving motor to low-speed and high-torque driving.

The decelerator 140 may be mounted inside the motor housing 120 with the output shaft 142 extending from the motor housing 120. The output shaft 142 extending from the motor housing 120 is fixed to the hub 132 of the wheel 130. Heat generated during operation of the decelerator 140 may be efficiently cooled by the air-blowing function of the fins 121 and the wheel 130. Although not illustrated, the elements of the wheel assembly 100 that rotate may be rotatably supported by bearings.

A drum break 150 may be accommodated inside of the wheel 130. The drum break 150 may be disposed to be closer to the wheel 130 than to the motor housing 120 and may be coupled to the wheel 130. The drum break 150 may be fixed to the hub 132 of the wheel 130 to thereby be rotated with the wheel 130. Various breaking devices, besides the drum break 150, for example, a disk break, may be provided inside the wheel 130.

The fins 121 may be arranged on the circumference of the motor housing 120 along a rotation direction of the wheel 130. The fins 121 may be spaced apart from each other along the rotation direction of the wheel 130, and may be extended in a direction parallel to a rotation axis of the wheel 130. Accordingly, the air from the wheel 130 can smoothly flow between the fins 121, exchanging the heat with the fins 121 and the motor housing 120. The fins 121 may be made of a thermal conductive material to enhance the heat exchange performance. For example, the fins 121 may be formed of a metallic material such as an aluminum alloy with a high thermal conductivity.

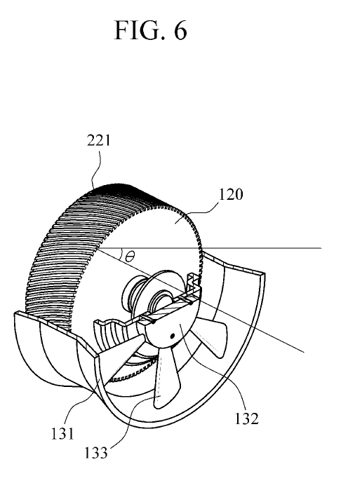

As shown in FIG. 6, for another example, the fins 221 may be disposed along the rotation direction of the wheel 130 at predetermined intervals, and be inclined with respect to the rotation axis of the wheel 130. The inclination direction and inclination angle θ of the fins 221 may vary within a range that can reduce air-flow resistance on the fins 221.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A wheel assembly of an in-wheel system, comprising:
a driving motor configured to generate rotational power;
a motor housing configured to accommodate the driving motor, the motor housing comprising a plurality of fins on an outer surface thereof; and
a wheel configured to accommodate the motor housing inside, to be rotated by the rotational power generated by the driving motor, and to provide an air flow to cool the motor housing when rotated.

2. The wheel assembly of claim 1, wherein the wheel comprises:
a rim enclosing an outer circumference of the motor housing;
a hub configured to be rotated by the rotational power from the driving motor; and
a plurality of blades arranged between the rim and the hub and around a rotation axis of the hub and configured to provide an air flow when the hub is rotated, wherein each of the plurality of blades has one end connected to the rim and another end connected to the hub.

3. The wheel assembly of claim 2, wherein the blades have a shape that sends air from the motor housing to an outside of the wheel when the wheel is rotated.

4. The wheel assembly of claim 2, wherein the blades have a shape that sends air from an outside of the wheel to the motor housing when the wheel is rotated.

5. The wheel assembly of claim 1, wherein the fins are formed on an outer circumferential surface of the motor housing along a rotation direction of the wheel.

6. The wheel assembly of claim 5, wherein the fins are spaced apart from each other along the rotation direction of the wheel and extend in a direction parallel to a rotation axis of the wheel.

7. The wheel assembly of claim 5, wherein the fins are spaced apart from each other along the rotation direction of the wheel and extend at an angle with respect to a rotation axis of the wheel.

8. The wheel assembly of claim 1, wherein the fins are made of a thermal conductive material.

9. The wheel assembly of claim 1, wherein the driving motor comprises:
a stator fixed to an inner wall of the motor housing; and
a rotor disposed in the stator.

10. The wheel assembly of claim 9 further comprising:
a decelerator configured to reduce a rotation speed of the rotor and transfer the reduced rotation speed to the wheel.

11. The wheel assembly of claim 1 further comprising:
a drum break coupled to and accommodated inside the wheel.

12. A wheel assembly comprising:
a wheel;
a motor housing that is accommodated within the wheel, the motor housing comprising a plurality of fins protruding from an outer surface; and
a driving motor that is accommodated within the motor housing and configured to generate rotational power to rotate the wheel,
wherein the wheel comprises a plurality of blades configured to generate an air flow to cool the motor housing when the wheel is rotated.

13. The wheel assembly of claim 12, wherein the motor housing has a cylindrical shape and the fins protrude from an outer circumferential surface of the motor housing in a radial direction.

14. The wheel assembly of claim 13, wherein the fins are spaced apart from each other along a rotation direction of the wheel and extend in a direction parallel to a rotation axis of the wheel.

15. The wheel assembly of claim 13, wherein the fins are spaced apart from each other along a rotation direction of the wheel and extend at an angle with respect to a rotation axis of the wheel.

16. The wheel assembly of claim 12, wherein the wheel further comprises:
a rim surrounding an outer circumference of the motor housing; and
a hub disposed in an inner space enclosed by the rim and configured to be rotated by the rotational power generated by the driving motor,
wherein each of the blades has one end connected to the rim and another end connected to the hub.

17. The wheel assembly of claim 16, wherein the blades have a shape that sends air from the motor housing to an outside of the wheel when the wheel is rotated.

18. The wheel assembly of claim 16, wherein the blades have a shape that sends air from an outside of the wheel to the motor housing when the wheel is rotated.

19. The wheel assembly of claim 12 further comprising a decelerator mounted inside the motor housing, and configured to reduce a rotation speed of the rotor and transfer the reduced rotation speed to the wheel.

20. The wheel assembly of claim 12, wherein the fins are made of a thermal conductive material.
